(19) United States
(12) Patent Application Publication
(10) Pub. No.: US 2005/0226021 A1
(43) Pub. Date: Oct. 13, 2005

(54) System and methods for generating mobile power

(76) Inventor: Nha Q. Do, Hayward, CA (US)

Correspondence Address: TRAN & ASSOCIATES, 6768 MEADOW VISTA CT., SAN JOSE, CA, 95135, US

(21) Appl. No.: 10/820,895

(22) Filed: Apr. 8, 2004

(51) Int. Cl. H02M 7/5387

(52) U.S. Cl. 363/146

(57) ABSTRACT

Systems and methods are disclosed for providing a mobile power device to supply alternating current (AC) voltage to an appliance. The power device has an enclosure having a first chamber and a second chamber, the enclosure having an AC output adapted to power the appliance; one or more user-replaceable energy storage units adapted to be inserted into the first chamber; an external power source coupled to the one or more energy storage units and adapted to charge the energy storage units; and an inverter positioned in the second chamber coupled to the one or more energy storage units and the AC output, the inverter receiving direct current (DC) voltage from the one or more energy storage units and generating AC voltage.

The present invention relates to mobile power generation.

With today's life style, mobility is an important factor. However, practically every electrical appliance requires 110V AC electricity to operate. A range of appliances has been developed to provide a power source at locations where it is either not practical and/or dangerous to be connected to mains power. One commonly used method involves the use of a fuel-driven generator. However, such generators are heavy, large, lack ready portability and are not practical for use in automobiles, caravans and boats. Generators also generally produce mains (AC) power which can be dangerous to users, especially in wet conditions.

An alternative and more compact form of power source is based on harnessing the sun's energy through solar panels. However, these systems are expensive, weather dependent and may not necessarily produce sufficient current for particular needs. An innate problem with solar power systems arises from the fact that energy impact per unit of surface area is not sufficiently high to provide concentrated power generation.

Inverters are also available to invert low direct current (“DC”) voltage such as around 8-12 volts to alternating current (“AC”) mains power levels, i.e. around 220-240 volts. However, such inverters are expensive and readily deplete the DC voltage power supply. Furthermore, the mains power output is dangerous to potential users, especially in inclement weather.

Conventional power supplies and/or generators include the Yamaha EF1000iS Generator. The EF1000iS Generator is a gasoline engine capable of providing maximum AC output of 1000 Watts of power on a continuous operation of 12 hours. However, it is gasoline operated, which emits fumes and possible pollution over time. The engine produces noise-leveling from 47 dBA at ¼ load up to 57 dBA at full load, and maintenance and repairs are necessary.

Another Portable Generator vendor is Briggs & Stratton. Briggs & Stratton portable generators are gasoline engine capable of providing AC output at various capacities. However, it is also gasoline operated, which emits fumes and possible pollution over time. The engine produces noise during usage. The unit is also bulky and requires relatively large space to operate. The generator's weight varies from 55 lbs up to 283 lbs. Additionally, maintenance and repairs are necessary.

Yet another vendor is Xantrex which markets the Portawattz 3000. The Portawattz 3000 is an inverter, which inverts 12 Volts from battery and converts the 12V to a 115 Volt AC household power, with output power at 2500-Watts continuous with a 5000-Watts surge. However, the unit requires an external 12 Volt battery source to operate. It outputs only AC Power. Also, installation is required by hardwiring AC output to battery, and the inverter may need mounting as well. When connected to a vehicle, boat, or RV, constant running of the engine is necessary to provide 12-Volt power source and thus the unit is restrictively portable when operated with the vehicle. Further, certain unit requires forty or more hours to fully charge its internal rechargeable battery.

U.S. Pat. No. 5,381,328—discloses a PWM inverter system having a sine (low-pass) filter. The sine filter includes a reactor and a capacitor, and is connected to the output of a PWM inverter. The instantaneous current flowing through the capacitor, and the instantaneous output current supplied from the sine filter to a load are detected. An instantaneous voltage command value is corrected on the basis of the detected current values. This makes it possible to limit oscillating waveforms involved in the output voltage of the PWM inverter without using a damping circuit which was connected in parallel with the capacitor in a conventional sine filter. The capacitor of the sine filter may be composed of a plurality of capacitors connected in parallel, and this will serve to further reduce the size of the sine filter. In a parallel operation of a plurality of PWM inverters, a cross current, that is, the difference between an instantaneous output current command value and an instantaneous capacitor current command value is reduced by correcting the instantaneous voltage command value. This makes it possible to share the current assigned to each PWM inverter with high stability.

U.S. Pat. No. 6,624,635 discloses an uninterruptable power supply for use with an Internet Telephone or Internet Telephone Cable Modem. The power supply includes a power supply, a load, an AC/DC converter for producing converter DC, and a rechargeable battery. A DC output multiplexer selects one of such DC sources and furnishes it to the load. The multiplexer has an input control signal for switching the DC source to a battery, and an output indicator indicating when the battery is acting as the DC source. The load includes a controller which generates this test signal at times when it is useful to test the battery, and accepts the indicator signal to know when the battery is providing this current. The controller includes a test function for measuring the reserve charge of the battery by measuring the temporal voltage drop and time of this temporal voltage drop with the use of an A/D converter. Additionally, the controller measures the charge and discharge intervals of the battery. The controller includes NVRAM which stores the test state, and an internet connection for the passage of messages to and from the internet.

U.S. Pat. No. 6,628,011 discloses a DC to DC Converter including an electrical circuit that allows batteries and other electrical energy storage devices to be charged from or to discharge to a variable voltage DC bus. This electrical circuit also enables seamless integration with other energy storage devices and/or DC power sources, such as fuel cells, to provide DC power for a Power Management System. A Power Management System preferably provides both full power source management and power conditioning. The Power Management System is able to manage power flow to and from multiple, isolated power sources and energy storage devices to deliver high quality alternating current (“AC”) power to a load.

U.S. patent application Ser. No. 20040012268 discloses a portable power converter with input means to receive low voltage DC input from an independent power source such as a 12V battery or power pack through an input lead 16. This connection may be effected with alligator clips, adjustable ring clamps or any suitable methods. The input lead is in turn connected to a low DC to high DC voltage power converter situated in a compartment of enclosure or housing. The enclosure or housing may have two or more compartments. One of the compartments may be formed by the walls of a container for the power converter where the container is fixed to a wall of the enclosure or housing.

### SUMMARY

Systems and methods are disclosed for providing a mobile power device to supply alternating current (AC) voltage to an appliance.

In one aspect, the power device has an enclosure having a first chamber and a second chamber, the enclosure having an AC output adapted to power the appliance; one or more user-replaceable energy storage units adapted to be inserted into the first chamber; an external power source coupled to the one or more energy storage units and adapted to charge the energy storage units; and an inverter positioned in the second chamber coupled to the one or more energy storage units and the AC output, the inverter receiving direct current (DC) voltage from the one or more energy storage units and generating AC voltage.

Implementations of the above aspect can include one or more of the following. The first chamber comprises a movable door to insert the energy storage units. Each energy storage unit comprises a battery. Each energy storage unit can be a dry-cell battery or a wet-cell battery. The energy storage unit can be a high capacity capacitor. The external power source can be a battery charger. The external power source can include a step-down transformer and a capacitor. The external power source can be an AC line cord connected to an AC to DC converter positioned in the second chamber. The inverter can be a pulse-width-modulated (PWM) inverter. A sine-wave filter can be connected to the PWM inverter output to provide sinusoidal AC output. The enclosure or housing can be waterproof. A handle can be attached to the enclosure. A back-up energy storage device can be connected to the inverter to provide temporary power to maintain the AC voltage while one or more of the user-replaceable energy storage units are replaced.

In another aspect, a system includes a mobile power device to supply alternating current (AC) voltage to an appliance, the power device having an enclosure having a first chamber and a second chamber, the enclosure having an AC output adapted to power the appliance; one or more user-replaceable energy storage units adapted to be inserted into the first chamber; an external power source coupled to the one or more energy storage units and adapted to charge the energy storage units; and an inverter positioned in the second chamber coupled to the one or more energy storage units and the AC output, the inverter receiving direct current (DC) voltage from the one or more energy storage units and generating AC voltage; and a back-up energy storage device coupled to the inverter to provide temporary power to maintain the AC voltage while one or more of the user-replaceable energy storage units are replaced.

In yet another aspect, a method of operating a mobile power device to supply alternating current (AC) voltage to an appliance includes inserting one or more user-replaceable energy storage units into the mobile power device; applying an external power source to charge the energy storage units; and converting direct current (DC) voltage from the one or more energy storage units and generating AC voltage to power the appliance.

In one implementation, the energy storage units can be substituted in the field without interrupting power to the appliance by using a back-up energy source.

Advantages of the above system may include one or more of the following. The system is a rechargeable battery operated DC/AC power source. The system provides a safe, inexpensive and convenient power supply for providing power to operate appliances such as computers, entertainment electronics, household appliances, camping equipment, and other field equipment. The system is easily portable and independent of mains power supply. Its internal rechargeable battery can be fully charged in a short time. The system is capable of providing DC/AC power in two states: (1) direct connection to external power outlet, where external power is used to recharge battery while providing AC voltage to connected appliance or (2) battery operated state, where battery voltage is converted to DC/AC voltage for connected appliance.

The portable power source may be used in a variety of useful applications such as in camping, in road or boating safety, for a variety of work that require AC power. The unit is portable, lightweight and all the components can be located in close proximity such as on or in the enclosure or housing. The energy storage units can be substituted in the field without interrupting power to the appliance by using a back-up energy source. This allows computers and other power sensitive devices to operate without needing to shut-down or restart.

### BRIEF DESCRIPTION OF THE DRAWINGS

The present invention is now described with reference to the following Drawings. This is done, however, with the understanding that the present invention encompasses all variations to the mobile power converter and its various uses.

FIG. 1 illustrates an exemplary mobile power system.

FIG. 2 illustrates an exemplary front, side and top view of an exemplary mobile power system.

### DESCRIPTION

Reference herein to the term “portable” includes reference to the components of the power unit being arranged in a enclosure or housing or other container and which can be readily carried or transported by a person. The enclosure or housing may be in compartmental form. In one embodiment, the enclosure or housing is in multiple compartment form where two or more compartments may be integrally connected or produced separately and placed together in a demountable or detachable arrangement. Preferably, however, the components of the power converter are located within one or more compartments of a enclosure or housing and energy storage devices such as batteries are in a user-accessible compartment. Also, “appliance” may be any appliance capable of operating under AC voltage. The term “appliance” includes one item or multiple items. If multiple items are employed, they may be all the same or different appliances.

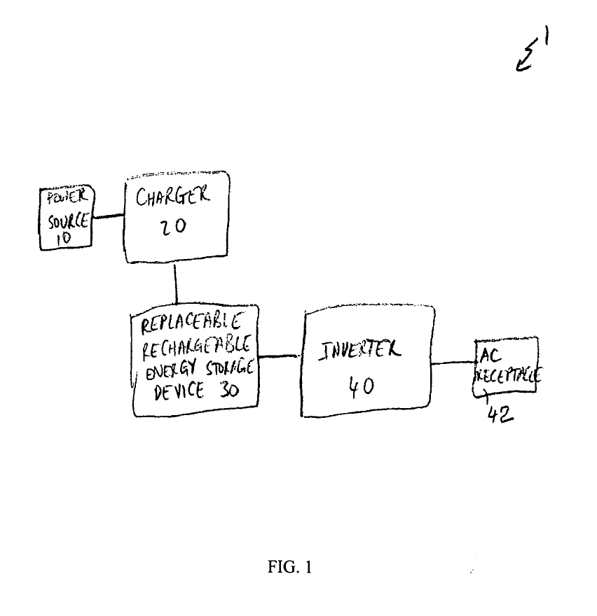

FIG. 1 shows one embodiment of a mobile power unit 1. A power source 10 provides recharging power to a charger 20 with a direct current (DC) Load Control and Battery Protection circuit. The output of the charger 20 is provided to one or more energy storage devices 30 such as battery units. The output of the battery units in turn is provided to an inverter 40 for generating AC voltages to operate mobile equipment. A number of standard inverters can be used. In one embodiment, the battery units 30 in combination form a 12V battery system and the inverter 40 converts 12 volts to 115-volt AC household power. A compartmentalized enclosure is conveniently capable of receiving and/or storing all the electrical leads from a recharging AC voltage supply as well as supplying the AC output voltage to an appliance through an AC receptacle 45. Most preferably, the charger 20 and the battery unit 30 are stowable on or within the en closure or housing.

In one embodiment, the mobile power unit 1 is enclosed in a handheld enclosure and the power source 10 is the AC power line. In this embodiment, the charger 20 includes an external AC adapter that provides a predetermined DC voltage/current from the AC power input. The DC voltage is applied to the battery units 30 after suitable load control and battery protection circuits. In another embodiment, the power source 10 is embedded inside the enclosure of the mobile power unit 1.

In yet another embodiment, the power source 10 can be one or more solar cells that produce the predetermined DC voltage needed by the battery charging circuit. The number of solar cells connected together in this embodiment may also be increased making it easy to change the solar cell output. The solar cells can be connected in parallel to increase the supply current, or can be connected in series to increase the supply voltage.

The battery unit 30 is rechargeable and is user-replaceable. In one embodiment, the battery unit 30 resides in one compartment of the enclosure for the mobile power unit 1. A slidable door on the enclosure allows the user to swap the batteries. Preferably, high capacity, rapid recharge batteries are used.

The charger 20 is tailored for each battery technology in the battery unit 30, including nickel cadmium (Ni-CD) batteries, lithium ion batteries, lead acid batteries, among others. For example Ni-CD batteries need to be discharged before charging occurs.

The battery can use solid polymer battery technology such as lithium-ion cells that immobilize the solution within the battery by trapping them in a polymer matrix, or by introduction of a gelling compound. Alternatively, a solid polymer such as Solicore's electrolyte can be used. The electrolyte is a true solid polymer, with no solvents. It has high current carrying capacity and maintains this performance level across a wide temperature range.

The energy storage device can also be a supercapacitor, which is a component intermediate between a capacitor and a battery in terms of energy and power. A battery delivers a great deal of energy (40 to 150 Wh/kg) but this component is limited in terms of power (<5.times.10.sup.2 W/kg). A capacitor delivers a high pulse power (10.sup.4 to 10.sup.6 W/kg) but its associated energy per unit mass is low (<0.1 Wh/kg). The term “supercapacitor” should be understood to mean any electrochemical system using at least the surface properties of an ideally polarizable material of high specific surface area. In other words, the super-capacitor is an electrochemical capacitor of high capacitance.

The origin of the operation of a supercapacitor is based on the principle of the double layer. During charging of the supercapacitor, there is a build-up of ionic species on either side of the two electrodes, at the ideally polarizable material/electrolyte interface. There may also be oxidation-reduction reactions in the presence of redox sites, resulting in a pseudocapacitive system. Supercapacitors based on the principle of the double layer have been manufactured from a variety of materials. These supercapacitors are assembled from two carbon electrodes having a high specific surface area. In general, the capacitors include current leads, a separator lying between the electrodes, an electrolyte and a package sealed with respect to the environment. One component of a supercapacitor consists of the electrolyte which, typically, comprises a solution of a salt, that is to say a combination of a salt and a solvent. In general, the electrolytes are low-viscosity liquids and have a high conductivity over a wide temperature range. They must also be of low cost, chemically and electrochemically stable and compatible with carbon or the other materials of which the electrodes are composed.

The inverter 40 also receives a back-up energy source such as a small battery or a high capacity capacitor. A current sensor is provided to sense current from the battery unit 30. Once the current is interrupted during operation indicating that the energy storage units are being replaced or that it has lost power, the inverter is connected to the back up energy source by a solid state switch or a relay. In this manner, the user-replaceable battery units 30 can be substituted in the field without interrupting power to the appliance by using the back-up energy source. The inverter 40 receives a low DC voltage input in electrical communication and provides a source of high DC voltage. The AC voltage to an appliance may be by an electrical lead directly from the voltage converter to the appliance or via a switch mechanism or an electrical plug or socket. In one embodiment, a standard AC wall plug connected to the inverter 40 operably supplies the high DC voltage to an appliance.

The inverter 40 can be a step-up transformer capable of amplifying low DC voltage to high DC voltage. The term “low voltage DC” generally encompasses voltages within the range from about 5 volts to about 50 volts DC and more preferably from about 6 volts to about 36 volts DC and even more preferably from about 8 volts to about 24 volts DC. Particularly preferred low voltages are about 8, 12, 24 or 36 volts with a variation of about 4 volts. High voltage AC encompasses voltages within the range from about 280 to about 480 volts AC. At high voltage levels power may be supplied over long distances with a voltage drop with minimal adverse effect on the system. As a result, the user can effectively power an end appliance at a great distance from the power source and portable converter. This is advantageous in a situation where a mobile appliance is energized by the system. The mobile power unit and the appliance, singly or in combination, may be moved widely and freely.

In one embodiment, the inverter can be pulse-width modulated inverter. A PWM inverter is controlled by a control circuit, and the output of the PWM inverter is supplied to a sine wave filter (LC low-pass filter). The sine filter includes an LC filter composed of a reactor and a capacitor, and a damping circuit which is a serial circuit of a resistor and a capacitor. The damping circuit is connected in parallel with the capacitor in order to limit oscillation waveforms accompanying the resonance of the reactor and the capacitor. The control circuit comprises a mean value circuit, an automatic voltage regulator (AVR), an instantaneous voltage command value generator, and a PWM signal generator. First, a voltage detector is connected to the output of the sine filter to detect the instantaneous output voltage V of the sine filter. The output voltage V is inputted to the mean value circuit. The mean value circuit produces the mean value of the instantaneous output voltage. The mean value is subtracted from a predetermined voltage reference value by a summing point, and the difference is supplied to the automatic voltage regulator. The automatic voltage regulator corrects the voltage reference value so that the difference becomes zero, and supplies the resultant corrected voltage reference value to the instantaneous voltage command value generator. The instantaneous voltage command value generator, receiving the corrected voltage reference value VA and a predetermined frequency reference value, generates a sinusoidal instantaneous voltage command value having amplitude determined by the corrected voltage reference value VA and a frequency determined by the frequency reference value. The output voltage V is subtracted from the instantaneous voltage command value by a summing point 82, and the difference is provided to a gain adjuster. The output of the gain adjuster is added to the voltage command value by a summing point that outputs a corrected voltage command value to the PWM signal generator. The PWM signal generator outputs a pulse signal corresponding to the corrected voltage command value and controls the PWM inverter by the pulse signal.

The foregoing describes the control of one PWM inverter in one embodiment. In another embodiment, a plurality of PWM inverters can be connected in parallel to supply power to a common load.

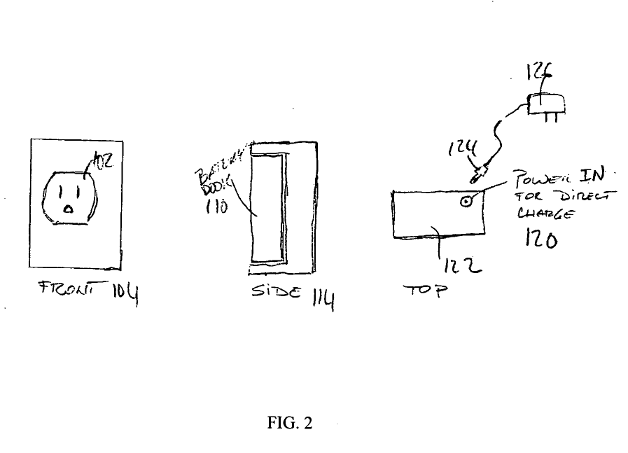

A suitable enclosure or housing is selected which is compact, easy to carry and which can accommodate the various components. FIG. 2 illustrates an exemplary front, side and top view of one particular enclosure or housing. The enclosure or housing can include a handle 102 for ready transportation by hand. An AC receptacle 102 is provided on a front face 104 of this embodiment. A battery door 110 is provided on one side 114 of the enclosure. A power receptacle 120 is provided on another side 122 of the enclosure. The power receptacle 120 is adapted to receive a power plug 124 from an AC-adapter 126 in this embodiment. In other embodiments, the power receptacle 120 can be an AC receptacle that receives an AC power cord. The AC input receptacle is then provided to a step down transformer/capacitor circuit to supply DC voltage to charge the battery units.

Other accessories may also be included such as connector means (e.g. alligator clips, cigarette lighter plug, etc.) for a 12 volt power source as well as spare lamps and fuses. In an alternative embodiment, some or all of these components may be located on the outside of the box. Preferably, all electrical fittings are in a form in which they are protected from wet and damp conditions.

Although the present invention is particularly useful in the form of a portable power source, the components of the power source may also be mounted separately such as in an automobile or boat. Generally, such a mounting would be permanent or otherwise not designed for ready detachment. In one embodiment the enclosure or housing may include attachment means for fixing the enclosure or housing to a surface. The attachment means may be in the form of an aperture for receiving a fixing means such as a screw or stud. The screw may be inserted through the aperture and fixed to the wall of a boat, caravan or in any suitable location. Alternatively a stud may be fixed to the surface, located through the aperture with a nut and washer retention fixture applied. Clearly it is preferable to have at least two such apertures to provide additional support and rotational stability to the enclosure or housing. The apertures may be formed in external lugs molded integrally with the enclosure or housing members.

An indication light may be provided to indicate when either or both switches are switched to an “on” position. Additionally, a microcontroller can be used as a monitor that reads the voltage or potential at the battery terminals. In a preferred embodiment, the microcontroller also reviews the ambient temperature and temperature of the battery. The microcontroller may check any suitable indicia such as specific gravity of the fluid in wet cell batteries or electrolyte concentration. If the available power falls below a pre-selected threshold, the microcontroller may shut the system down and thereby avoid damage to the battery unit. After a preset time which may be varied by an operator, the microcontroller may be programmed to automatically conduct a brief check of power availability. If the critical point is exceeded, the system may be reactivated. Alternatively, if the critical point of power is still not available the system will close down again for the preset period before checking again. This cycle may be repeated throughout the close down period of the system. To further increase operational duration, the microcontroller may be programmed automatically to shut down during a period of inactivity. For example, the appliance may be shut down during the period from midnight to 6:00 am. The ability to selectively power or depower appliances increases energy efficiency and utility of the system. Any number of modifications may be made to the portable power converter such as but not limited to multiple output means and electrical means to prevent draining of power from battery units.

The above system powers any electrical appliances wherein the power source includes both an internal rechargeable battery, and a direct connect to external source, such as main (wall) voltage source. With the ability to carry power source anywhere, every electrical appliance is mobile and able to operate at remote places, or under blackout conditions. The system includes a compact rechargeable battery source, which provides electrical power for parts of a day. Thus, AC electrical power source can be available anywhere and everywhere.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations of any two or more of said steps or features.

1. A mobile power device to supply alternating current (AC) voltage to an appliance, comprising:
an enclosure having a first chamber and a second chamber, the enclosure having an AC output adapted to power the appliance;
one or more user-replaceable energy storage units adapted to be inserted into the first chamber;
an external power source coupled to the one or more energy storage units and adapted to charge the energy storage units; and
an inverter positioned in the second chamber coupled to the one or more energy storage units and the AC output, the inverter receiving direct current (DC) voltage from the one or more energy storage units and generating AC voltage.

2. The device of claim 1, wherein the first chamber comprises a movable door to insert the energy storage units.

3. The device of claim 1, wherein each energy storage unit comprises a battery.

4. The device of claim 1, wherein each energy storage unit comprises a solid polymer without solvent.

5. The device of claim 1, wherein each energy storage unit comprises a dry-cell or wet-cell battery.

6. The device of claim 1, wherein each energy storage unit comprises a capacitor.

7. The device of claim 1, wherein the external power source comprises a battery charger.

8. The device of claim 1, wherein the external power source comprises a step-down transformer and a capacitor.

9. The device of claim 1, wherein the external power source comprises an AC line, further comprising an AC to DC converter positioned in the second chamber.

10. The device of claim 1, wherein the inverter comprises a pulse-width-modulated (PWM) inverter.

11. The device of claim 10, further comprising a sine-wave filter coupled to the PWM inverter output.

12. The device of claim 1, wherein the enclosure or housing is waterproof.

13. The device of claim 1, further comprising a handle attached to the enclosure.

14. The device of claim 1, further comprising a back-up energy storage device coupled to the inverter to provide temporary power to maintain the AC voltage while one or more of the user-replaceable energy storage units are replaced.

15. A system, comprising:
a mobile power device to supply alternating current (AC) voltage to an appliance, the power device having an enclosure having a first chamber and a second chamber, the enclosure having an AC output adapted to power the appliance; one or more user-replaceable energy storage units adapted to be inserted into the first chamber; an external power source coupled to the one or more energy storage units and adapted to charge the energy storage units; and an inverter positioned in the second chamber coupled to the one or more energy storage units and the AC output, the inverter receiving direct current (DC) voltage from the one or more energy storage units and generating AC voltage; and
a back-up energy storage device coupled to the inverter to provide temporary power to maintain the AC voltage while one or more of the user-replaceable energy storage units are replaced.

16. The system of claim 15, wherein the first chamber comprises a movable door to insert the energy storage units.

17. The system of claim 15, wherein each energy storage unit comprises a battery.

18. The system of claim 15, wherein the energy storage unit comprises a capacitor.

19. A method of operating a mobile power device to supply alternating current (AC) voltage to an appliance, comprising:
inserting one or more user-replaceable energy storage units into the mobile power device;
applying an external power source to charge the energy storage units; and
converting direct current (DC) voltage from the one or more energy storage units and generating AC voltage to power the appliance.

20. The device of claim 19, further comprising substituting the energy storage units in the field without interrupting power to the appliance.
